SEQUENCE LISTING (15 sequences)

SEQ ID NO: 1 - DNA, 876 bp, Artificial
  HyHEL10scFv-(G4S)3-WinZipA1
ggccatggaggccgatatccagctgcaggagtcgggcccgagcctcgtcaagccgtcgcagaccctgtcgctcacctgcagcgtcaccggcgactcgatcacctcggactactggtcgtggatccgcaagttccccggcaaccgcctcgagtacatgggctacgtcagctactcgggcagcacctactacaacccctcgctgaagagccgcatctcgatcacccgcgacacctccaagaaccagtactacctggacctcaactcggtcaccaccgaggacaccgccacctactactgcgcgaactgggacggcgactactggggccagggcaccctcgtcaccgtctctgcgggcgggggcggtagcggcggtggcgggtcgggcggtggcggatcggatatcgtcctgacccagagcccggcgaccctctcggtcacccccggcaactcggtgtccctctcgtgccgcgcctcgcagtcgatcggcaacaacctccactggtatcagcagaagtcgcacgagagcccgcgcctcctgatcaagtacgccagccagtcgatctcggggatcccgtcgcgcttcagcggctcgggctcgggcaccgacttcaccctgtcgatcaacagcgtcgagacggaggacttcggcatgtacttctgccagcagtcgaacagctggccgtacaccttcggcggcggtaccaagctgatcatcacggccggcgggggcggtagcggcggtggcgggtcgggcggtggcggatcgactgtggcgcaactggaggaaaaggtgaaaacccttcgtgctcagaattatgaacttaagtctcgtgtgcagcgcttgcgtgagcaggttgcccagcttgctgcggccgc

SEQ ID NO: 2 - protein, 285 aa, Artificial
  HyHEL10scFv-(G4S)3-WinZipA1
DIQLQESGPSLVKPSQTLSLTCSVTGDSITSDYWSWIRKFPGNRLEYMGYVSYSGSTYYNPSLKSRISITRDTSKNQYYLDLNSVTTEDTATYYCANWDGDYWGQGTLVTVSAGGGGSGGGGSGGGGSDIVLTQSPATLSVTPGNSVSLSCRASQSIGNNLHWYQQKSHESPRLLIKYASQSISGIPSRFSGSGSGTDFTLSINSVETEDFGMYFCQQSNSWPYTFGGGTKLIITAGGGGSGGGGSGGGGSTVAQLEEKVKTLRAQNYELKSRVQRLREQVAQLA

SEQ ID NO: 3 - DNA, 882 bp, Artificial
  HyHEL10scFv-(G4S)3-WinZipA1
ggccatggaggcccaggtgcagctgcaggagtcaggacctggcctggtggcgccctcacagagcctgtccatcacatgcaccgtctcagggttctcattaaccggctatggtgtaaactgggttcgccagcctccaggaaagggtctggagtggctgggaatgatttggggtgatggaaacacagactataattcagctctcaaatccagactgagcatcagcaaggacaactccaagagccaagttttcttaaaaatgaacagtctgcacactgatgacacagccaggtactactgtgccagagagagagattataggcttgactactggggccaaggcaccacggtcaccgtctcctcaggtggaggcggttcaggcggaggtggctctggcggtggcggatcggacatcgagctcactcagtctccagcctccctttctgcgtctgtgggagaaactgtcaccatcacatgtcgagcaagtgggaatattcacaattatttagcatggtatcagcagaaacagggaaaatctcctcagctcctggtctattatacaacaaccttagcagatggtgtgccatcaaggttcagtggcagtggatcaggaacacaatattctctcaagatcaacagcctgcaacctgaagattttgggagttattactgtcaacatttttggagtactcctcggacgttcggtggagggaccaagctcgagatcaaacggggcgggggcggtagcggcggtggcgggtcgggcggtggcggatcgtccgttgacgaactgcaggctgaggttgaccagctgcaggacgagaattacgctctgaagaccaaggttgcgcagctgcgtaaaaaggtggaaaagctggcggccgc

SEQ ID NO: 4 - protein, 287 aa, Artificial
  HyHEL10scFv-(G4S)3-WinZipA1
QVQLQESGPGLVAPSQSLSITCTVSGFSLTGYGVNWVRQPPGKGLEWLGMIWGDGNTDYNSALKSRLSISKDNSKSQVFLKMNSLHTDDTARYYCARERDYRLDYWGQGTTVTVSSGGGGSGGGGSGGGGSDIELTQSPASLSASVGETVTITCRASGNIHNYLAWYQQKQGKSPQLLVYYTTTLADGVPSRFSGSGSGTQYSLKINSLQPEDFGSYYCQHFWSTPRTFGGGTKLEIKRGGGGSGGGGSGGGGSSVDELQAEVDQLQDENYALKTKVAQLRKKVEKL

SEQ ID NO: 5 - protein, 32 aa, Maackia amurensis
VDELQAEVDQLQDENYALKTKVAQLRKKVEKL

SEQ ID NO: 6 - DNA, 31 bp, Artificial
  Synthesized
ggccatggaggccgatatccagctgcaggag

SEQ ID NO: 7 - DNA, 31 bp, Artificial
  Synthesized
gcggccgcagcaagctgggcaacctgctcac

SEQ ID NO: 8 - DNA, 29 bp, Artificial
  Synthesized
ggccatggaggcccaggtgcagctgcagg

SEQ ID NO: 9 - DNA, 30 bp, Artificial
  Synthesized
gcggccgccagcttttccacctttttacgc

SEQ ID NO: 10 - DNA, 33 bp, Artificial
  Synthesized
gtcgacaagcttgcggccgcactcgagcaccac

SEQ ID NO: 11 - DNA, 32 bp, Artificial
  Synthesized
aattaattccggcctccatggccatcgccggc

SEQ ID NO: 12 - DNA, 25 bp, Artificial
  Synthesized
aaaagcggccgcagatcaaacgggg

SEQ ID NO: 13 - DNA, 26 bp, Artificial
  Synthesized
cgagccgcggcgccagcttttccacc

SEQ ID NO: 14 - DNA, 27 bp, Artificial
  Synthesized
tatataccgcggataggtgcgccggtg

SEQ ID NO: 15 - DNA, 31 bp, Artificial
  Synthesized
ggcctccatggccgcatagaaaggaacaact

(19) United States
(12) Patent Application Publication
(10) Pub. No.: US 2006/0275811 A1
(43) Pub. Date: Dec. 7, 2006

(54) Method for producing target substance capturing protein and method for selecting component materials thereof

(75) Inventors: Satoru Hatakeyama, Kawasaki-shi (JP); Hidenori Shiotsuka, Sagamihara-shi (JP); Tsuyoshi Nomoto, Tokyo (JP); Masaru Kaieda, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/444,387

(22) Filed: Jun. 1, 2006

(30) Foreign Application Priority Data
Jun. 3, 2005 (JP) 2005-164550

(51) Int. Cl. C40B 30/06; C40B 40/08; C40B 40/10

(52) U.S. Cl. 435/6; 435/7.1

(57) ABSTRACT

A combination of polypeptide chains used as a plurality of target substance-binding domains are selected by: (1) reacting a target substance with a first polypeptide chain with a known target substance-binding domain to obtain a first complex; (2) reacting the first complex with a second polypeptide chain library composed of polypeptide chains each having a site to be associated with the first polypeptide chain to obtain second complexes in which the second polypeptide chain is bonded with the target substance in the first complex; (3) washing the second complexes to obtain a third complex in which the first polypeptide chain and the second polypeptide chain are associated with each other and bonded with the target substance; and (4) obtaining a nucleic acid sequence of the second polypeptide chain from the third complex.

### BACKGROUND OF THE INVENTION

1. Field of the Invention

The present invention relates to a method for producing a target substance capturing protein useful in a variety of studies on the detection, isolation or inhibition of a target substance or on the interaction between proteins and to a method for selecting polypeptides used in the production thereof.

2. Related Background Art

Protein-protein interaction typified by antibody-antigen, receptor-ligand and enzyme-substrate interaction plays a key role in the control of vital phenomena in all organisms. One of focuses of biochemical studies and intracellular signaling studies is to understand specific recognition and binding by protein-protein interaction. Particularly antibody-related studies have been performed since a long time ago and have produced many findings. Based on the obtained findings, attempts have been made to overcome demerits arising from the low productivity, low affinity and large molecular sizes of complete antibodies. These attempts include the creation of more functional, novel antibodies and the creation of various functional proteins produced on the basis of structures other than antibodies and intended for use and molecular recognition in a variety of applications to atmospheres disfavored by antibodies. Furthermore, screening (display) methods and selection methods for these functional proteins have been examined. As described above, techniques for efficient and systematic creation and selection of functional molecules are increasingly important in fields such as antibody drugs and diagnostic devices.

Hereinafter, techniques related to target substance capturing proteins (polypeptides) for capturing target substances by utilizing protein-protein interaction will be described on an item-by-item basis.

(1) Use of Antibodies as Binding Domains for Target Substances

Representative examples of the target substance capturing protein can include antibodies. Among them, monoclonal antibodies have the function of recognizing and binding to single target substances and are widely put in practical use in medical and food hygiene fields such as the diagnosis of human cancer and the detection of pathogenic bacteria and food poisoning bacteria. The monoclonal antibody is an antibody produced by a hybridoma derived from a single clone. The hybridoma is constructed from the cell fusion between a splenic B cell of an animal immunized with an antigen and a myeloma cell. Hybridoma is a cell having B cell-derived ability to produce antibodies together with myeloma cell-derived ability of unlimited proliferation. By further cloning, monoclonal antibody which is homogeneous and specific to an antigen can be produced.

The most general structure of an antibody (IgG) consists of four polypeptide chains, that is, two heavy (H) chains and two light (L) chains mutually linked through disulfide bond. The L chains exist in two different forms called kappa (κ) and lambda (λ). The H and L chains respectively have constant (C) and variable (V) regions. The chains are organized in a series of domains. The L chain has two domains, of which one corresponds to the C region and the other corresponds to the V region. The H chain has four domains, of which one corresponds to the V region and the remaining three domains correspond to the C regions. The antibody has two identical units (each located in the Fab region), each of which has the VL and VH regions mutually related. A certain antibody differs from others in this pair (VL and VH) of the V region, and both regions in this pair participate in recognizing antigens and providing an antigen-binding-domain (ABS).

To be more specific, each V region consists of three complementarity-determining regions (CDR) divided by four framework regions (FR). The CDR is a portion most likely to vary in the variable region and achieves essential antigen-binding function. The CDR regions are obtained from a large number of a series of potential reconstructed sequences through complicated steps comprising recombination, mutation and selection.

(2) Use of Antibody Fragments as Binding Domains for Target Substances

Problems presented by monoclonal antibodies obtained by conventional hybridoma techniques serve as a backdrop to the development of a variety of antibody fragments. First, monoclonal antibody production requires very large-scale equipment and high cost. Secondly, since the affinity of monoclonal antibodies is founded on biological immune systems, a high-affinity molecule from a certain antibody is difficult to obtain. Moreover, there are constraints such that molecules possessing autoimmunogenicity in source a animal hosts of B cells are eliminated by antigens for monoclonal antibody production.

Thus, the application of antibody fragments to binding domains for target substances has been examined.

(3) Improvement of Avidity of Antibodies and Antibody Fragments to Target Substances

As the types of substances to be captured as target substances are diversified, some types of target substances do not permit for the desired specific target substance recognition of antibodies or antibody fragments or the desired bond strength of antibodies or antibody fragments with the target substances when they are used as binding domains for the targets substances.

Methods for addressing such problems include the creation of multivalent binding molecules. This multivalent binding molecule has a plurality of binding domains for a target substance. Therefore, the multivalent binding molecule is expected to provide the improvement of affinity (avidity) to a target substance, the improvement of performance in in-vivo or in-vitro assay, their ability to target a target substance in vivo, and so on. The followings are known as such multivalent binding molecules:

miniantibodies in which scFv fragments are linked with hinge regions and oligomerization domains (Andreas Pluckthun et al., JBC Vol. 276, No. 17, 14385-14392 (2001)); and diabodies produced by the spontaneous dimerization of scFv fragments with short linkers or antibody fragments linked by chemical modification (Peter Pack et al., Immunotechnology 3, 83-105 (1997)).

Approaches for developing target substance capturing molecules with strong avidity (high affinity) to target substances from antibody fragments or derivatives thereof include the following: a method comprising artificially mutagenizing a domain of the antibody fragment or derivative thereof and evolutionarily selecting and obtaining a molecule improved in affinity to an antigen. Another approach is a method comprising combining the antibody fragments or derivatives thereof to obtain a molecule improved in affinity to a target substance in terms of the whole molecule by avidity effect.

The former method includes an approach for systematically selecting the molecule of interest by using phage display or mRNA display.

The latter method includes a method for obtaining the molecule of interest by connecting known antigen-binding domains via linkers. Greg Winter et al. (J. Mol. Biol. 246, 367-373 (1995)) obtained information about antigens and about the recognition and binding domains of antibodies by crystal structure analysis and disclosed the construction of a single polypeptide chain (scFv-scFv) by connecting antibody fragments (scFv) recognizing different epitopes of an identical target substance (antigen) via a linker. The constructed scfFv-scFv has been shown therein to have 2 to 3-digit higher affinity to the target substance than that of either of the scFv fragments.

(4) Target Substance Capturing Molecules Other than Antibodies and Antibody Fragments

Examination has been conducted on the creation of novel proteins having specific recognition and avidity to target substances without the use of animal immune systems themselves or information obtained with the immune systems. Such nonimmune-system target substance capturing molecules promise to be designed as desired from the stage of their construction for items related to the optimum design of molecular size, large-scale culture ability by E. coli or the like, structural stability, the presence or absence of disulfide bond, and the number of randomizable sites. Moreover, they are capable of targeting low-molecular-weight substances or the like difficult to recognize by antibodies or fragments thereof and can be expected as target substance capturing molecules that substitute for antibodies or antibody fragments.

Methods for constructing proteins as the nonimmune-system target substance capturing molecules include the following: a method comprising obtaining crystal structure information of a protein serving as a basis, identifying a region involved in structural maintenance (scaffold region), randomizing mainly amino acid residues not involved in structural maintenance, and selecting therefrom a structure having the function of specifically recognizing and binding to a target substance.

Andreas Pluckthun et al. (FEBS Lett. 539, 2-6 (2003)) has disclosed target substance-binding proteins optimized by identifying homologous regions as scaffold structures from an ankyrin family protein group and improving the basic structures. Moreover, the followings are also known as novel binding proteins that bind via beta-sheets or helix-turn-helix regions different from the antigen recognition pattern of antibodies via a plurality of CDR loop regions: ankyrin (Andreas Pluckthun et al., Nature Biotechnology Vol 22, No. 5, 575-582 (2004)); Affilin (Scil Proteins GmbH); and affibody (Per-Ake Nygren et al., Proteins: Structure, Function, and Genetics 48, 454-462(2002)).

The most promising strategy for creating novel antibody fragments and novel binding proteins is to make a limited library and perform screening or selection efficiently, conveniently and systematically according to desired properties.

(5) Acquisition of Target Substance Capturing Molecules without Use of Animal Immune Systems

Methods for obtaining antibodies or antibody fragments independently of animal immune systems include phage selection and mRNA selection. The pamphlet of International Publication WO92/01047 and U.S. Pat. No. 5,969,108 have disclosed a large number of members of a specific binding-pair (sbp) having induced random mutation, wherein bacteriophage particles display the sbp members on their surfaces and are repeatedly selected and grown with their binding affinity to the complementary sbp member as an index. In the techniques disclosed therein, the information of a nucleic acid encoding the sbp member displayed on the surface of the finally selected bacteriophage particle with high affinity to the complementary sbp member can be obtained.

The specific binding pair (sbp) members disclosed in these documents are not limited to antibodies (or antibody fragments) and include receptors and enzymes. These documents have suggested that CDR loops selected by the phage selection system are grafted onto TIM (triose phosphate isomerase) enzymes and so on structurally similar to antibodies to allow for the creation of a novel binding protein. These documents have also suggested that a genetically diverse population is produced by further mutagenesis to allow for the creation of a novel binding protein by selection.

Moreover, these documents have clearly demonstrated that the sbp consists of a multimer and have indicated that at least one of first and second polypeptide chains is applicable as a random nucleic acid library to this phage selection system. Additionally, the documents have disclosed that a multimer consisting of the first and second polypeptide chains can be formed on the surface of the bacteriophage particle.

U.S. Pat. No. 6,482,596 has disclosed an open sandwich method comprising immobilizing known VL on a carrier and selecting a phage displaying on its surface, VH having random mutation introduced therein in an expectation of highest stability by the VL/antigen/VH binding in the presence of the antigen.

The pamphlet of International Publication No. WO98/54312 has disclosed mRNA display as an in-vitro selection method that substitutes for phage selection. This method relates to the display and selection of proteins or peptides and to the collection of genetic materials encoding them. The method is characterized by displaying proteins (or peptides) on ribosomes as complexes with the eukaryotic ribosomes and the mRNA encoding the protein (or peptide). This complex is contacted with an antigen or the like on the ribosome to select randomized nascent proteins or peptides with their affinity as an index. This document has also disclosed examples of the selection of scFv by mRNA display.

(5) Multimerization of Binding Domains for Target Substances

As described above, the avidity to a target substance in terms of the whole target substance capturing molecule can be improved by using a molecule having a plurality of target substance-binding domains that specifically recognize and bind toga plurality of different sites of the target substance.

Methods for connecting a plurality of target substance-binding domains include: a method comprising using a linker for scFv-scFv; and a method comprising systematically selecting a coiled-coil hetero-associate from a library having introduced artificial coiled-coil mutation according to difference in hetero-associating ability (Andreas Pluckthun et al., J. Mol. Biol. 295, 627-639 (2000) and the pamphlet of International. Publication No. WO01/00814).

Methods for selecting a target substance capturing molecule include phage selection and mRNA selection, as described above. However, these selection techniques are capable of improving avidity (affinity) to a target substance at one site but halve a limit on the improvement of affinity.

On the other hand, the scFv-scFv illustrated above is known about the creation of target substance capturing molecules having multimerized binding domains for target substances. In this scFv-scFv, each Fv fragment is variously selected according to the types of target substances. However, it is necessary to optimize a linker for each selected scFv-scFv, based on the spatial arrangement of two targeted epitopes in an antigen (target substance). Furthermore, in this scFv-scFv, substances that can not be recognized by Fv can not be utilized as targets.

On the other hand, in a method for obtaining a novel hetero-associate consisting of two or more functional proteins by utilizing the coiled-coil structure, these two or more functional proteins are selected in advance according to the type of a target substance, followed by the formation of the hetero-associate. Therefore, this method is not a method for evolutionarily and systematically selecting a molecule specifically binding to the target substance from many candidates.

Alternatively, the phage selection or mRNA selection is likely to serve as the method for evolutionarily and systematically selecting a molecule specifically binding to the target substance from many candidates and however, in order to obtain target substance capturing molecules having multimerized binding domains for target substances, requires processing by which a plurality of selected molecules are optimized and linked to have function of interest In addition, it is sometimes necessary to reconfirm the affinity of the processed molecules to the target substances (antigens).

A promising strategy for creating target substance capturing molecules compatible with a variety of target substances is to create a limited library consisting of a large number of target substance-binding molecule candidates and establish the target substance-binding molecule that achieves efficient, convenient and systematic screening or selection according to desired properties. It is also important to establish a method which can conveniently select a target substance capturing molecule having multimerized binding domains for target substances capable of acquiring specific selectivity and avidity to the target substances in agreement with the types of the target substances.

However, a method which can evolutionarily and systematically obtain the target substance capturing molecule having multimerized binding domains for target substances by selecting each binding domain from a library and connecting the selected binding domains in arrangement capable of exhibiting desired function is not found in the conventional techniques.

### SUMMARY OF THE INVENTION

An object of the present invention is to provide a method for selecting polypeptide chains, which can systematically select from libraries, polypeptide chains serving as the respective target substance-binding domains of a target substance capturing protein with a plurality of target substance-binding domains in a state in which their binding positions for a target substance is optimized. Another object of the present invention is to provide a method for producing the target substance capturing protein with a plurality of target substance-binding domains, based on information about the polypeptide chains selected by this selection method.

A first aspect of the method for selecting nucleic acid sequences of polypeptide chains for target substance-binding domains according to the present invention is a method for selecting a combination of polypeptide chains used in the respective target substance-binding domains of a target substance capturing protein with a plurality of target substance-binding domains by utilizing a polypeptide chain library, comprising the steps of:

(1) reacting a target substance with a first polypeptide chain with a known target substance-binding domain to obtain a first complex consisting of the target substance and the first polypeptide chain specifically binding to the target substance;

(2) reacting the first complex with a second polypeptide chain library composed of polypeptide chains each having a site to be associated with the first polypeptide chain to obtain second complexes in which the second polypeptide chain specifically binding to the target substance in the library is bonded with the target substance in the first complex;

(3) washing the second complexes to obtain a third complex in which the first polypeptide chain and the second polypeptide chain are associated with each other and bonded with the target substance; and

(4) obtaining a nucleic acid sequence of the second polypeptide chain from the third complex.

In the first aspect, in the case of three or more target substance-binding domains,

first to n-th (n represents an integer of 3 or larger) polypeptide chain libraries are prepared, wherein polypeptide chains respectively selected from the libraries are capable of being associated with each other via association sites thereof;

the third to n-th polypeptide chain libraries are successively used to repeatedly perform the steps (2) and (3) for the third complex obtained by the steps (1) to (3) using the first polypeptide chain with a known target substance-binding domain and the second polypeptide chain;

the step (4) is performed to obtain a complex in which an associate of n polypeptide chains respectively selected from the libraries is bonded with the target substance; and

nucleic acid sequences of the polypeptide chains respectively selected from the libraries in a state in which the polypeptide chains are associated with each other on the target substance can be obtained.

A second aspect of the method for selecting nucleic acid sequences of polypeptide chains for target substance-binding domains according to the present invention is a method for selecting from polypeptide chain libraries, polypeptide chains used in the respective target substance-binding domains of a target substance capturing protein with a plurality of target substance-binding domains, comprising the steps of:

(1) reacting a target substance with a first polypeptide chain library to obtain a first complex consisting of the target substance and the first polypeptide chain specifically binding to the target substance;

(2) reacting the first complex with a second polypeptide chain library composed of polypeptide chains each having a site to be associated with the first polypeptide chain to obtain second complexes in which the second polypeptide chain specifically binding to the target substance in the library is bonded with the target substance in the first complex;

(3) washing the second complexes to obtain a third complex in which the first polypeptide chain and the second polypeptide chain are associated with each other and bonded with the target substance; and

(4) obtaining nucleic acid sequences of the first polypeptide chain and the second polypeptide chain from the third complex.

In the second aspect,

first to m-th (m represents an integer of 3 or larger) polypeptide chain libraries are prepared, wherein polypeptide chains respectively selected from the libraries are capable of being associated with each other via association sites thereof;

the third to m-th polypeptide chain libraries are successively used to repeatedly perform the steps (2) and (3) for the third complex obtained by the steps (1) to (3) using the first polypeptide chain library and the second polypeptide chain library to obtain a complex in which an associate of m polypeptide chains respectively selected from the libraries is bonded with the target substance; and

performing the step (4) to obtain nucleic acid sequences of the polypeptide chains respectively selected from the libraries in a state in which the polypeptide chains are associated with each other on the target substance can be obtained.

The method for producing a target substance capturing protein according to the present invention is a method for producing a target substance capturing protein, comprising the steps of:

(I) selecting two or more polypeptide chains capable of specifically binding to different sites of a target substance and being associated with each other by the selection method;

(II) producing the two or more polypeptide chains; and

(III) connecting the two or more polypeptide chains produced to obtain a target substance capturing protein with a plurality of respective binding domains specifically binding to the different sites of the target substance.

A first aspect of the polypeptide chain set according to the present invention is a polypeptide chain set for supplying polypeptide chains having target substance-binding domains of a target substance capturing protein with first and second to k-th (k represents an integer of 3 or larger) target substance-binding domains (including a target substance capturing protein consisting of the first and second target substance-binding domains), comprising:

(1) a known polypeptide chain for the first target substance-binding domain; and

(2) a polypeptide library having candidates of the second target substance-binding domain or second to k-th polypeptide libraries categorized in terms of respective candidates of the second to k-th target substance-binding domains,

wherein the first polypeptide chain and the polypeptide chains respectively selected from the libraries are capable of being associated with each other. Namely, this polypeptide chain set can be composed of only the known polypeptide chain for the first target substance-binding domain and the second polypeptide library as a target substance capturing protein with first and second target substance-binding domains.

A second aspect of the polypeptide chain set according to the present invention is a polypeptide chain set for supplying polypeptide chains forming target substance-binding domains of a target substance capturing protein with first to p-th (p represents an integer of 2 or larger) target substance-binding domains, comprising

first to path polypeptide chain libraries having respective candidates of the first to p-th target substance-binding domains,

wherein the first polypeptide chain and the polypeptide chains respectively selected from the libraries are capable of being associated with each other.

The nucleic acid set of the present invention is a nucleic acid set consisting of nucleic acids respectively encoding polypeptide chains constituting the polypeptide chain set.

The expression vector set of the present invention is an expression vector set comprising individual expression vectors respectively having the nucleic acids comprised in the nucleic acid set.

A first aspect of the kit for selecting polypeptide chains for target substance capturing protein production according to the present invention comprises:

the polypeptide chain set; and reagents for reaction between a target substance and the polypeptide chain set, for the washing of complexes and for the acquisition of the complex of interest from the complexes.

A second aspect of the kit for selecting polypeptide chains for target substance capturing protein production according to the present invention comprises:

the nucleic acid set; a reagent for obtaining a polypeptide chain set with the use of the nucleic acid set; and reagents for reaction between a target substance and the polypeptide chain set, for the washing of complexes and for the acquisition of the complex of interest from the complexes.

A third aspect of the kit for selecting polypeptide chains for target substance capturing protein production according to the present invention comprises:

the expression vector set; a reagent for obtaining a polypeptide chain set with the use of the expression vector set; and reagents for reaction between a target substance and the polypeptide chain set, for the washing of complexes and for the acquisition of the complex of interest from the complexes.

Advantages of the present invention will be described below.

First, in the present invention, a nascent protein is constructed to have two or more polypeptide chains forming the binding domains for the target substance, and these polypeptide chains are linked to each other via the association sites thereof. This allows for the selection of a high-affinity molecule with the use of avidity effect as a modification to conventional display techniques. Secondly, it is possible to efficiently select a nascent protein with high avidity by adjusting the avidity of the association sites of the polypeptide chains forming the binding domains for the target substance at the time of selection and by utilizing the avidity effect on the target substance. Thirdly, it is possible to evolutionarily select a high-affinity (high-avidity) nascent protein by artificially mutagenizing at least one target substance-binding domain of the polypeptide chains forming the binding domains for the target substance.

Fourthly, it is possible to select a higher-affinity (higher-avidity) nascent protein by setting an antibody fragment, novel binding protein, or mixture thereof to the target substance-binding domains of the polypeptide chains for target substance-binding domain formation constituting the nascent protein.

Fifthly, when a known target substance-binding domain is set to at least one of the polypeptide chains, it is possible to further improve the avidity of an avidity molecule that maintains the known specificity.

Sixthly, a higher-avidity nascent protein can be selected by selecting two or more functional polypeptide chains.

Seventhly, because the selection can be performed for the final molecular structure of the nascent protein, convenient and practical selection is made possible.

### BRIEF DESCRIPTION OF THE DRAWINGS

FIG. 1 is an illustrative diagram of a method for selecting functional polypeptide chains by phage display according to the present invention;

FIG. 2 is an illustrative diagram of the design of first and second polypeptide chains;

FIGS. 3A, 3B, 3C and 3D are illustrative diagrams of a variety of binding forms of the first and second polypeptide chains to a target substance;

FIG. 4 is a diagram showing the DNA sequence and amino acid sequence of HyHEL10 scFv-(G4S)3-WinZipA1;

FIG. 5 is a diagram showing the DNA sequence and amino acid sequence of D1.3 scFv-(G4S)3-WinZipB1 and the amino acid sequence of WinZipB1; and

FIG. 6 is a diagram showing the DNA sequences of a variety of primers.

### DETAILED DESCRIPTION OF THE PREFERRED EMBODIMENTS

In a selection method of the present invention, a structure in which a plurality of target substance-binding domains are arranged is obtained as a target substance capturing protein. Accordingly, for selecting the respective target substance-binding domains, polypeptide chains properly arranged on a target substance are selected from polypeptide chain libraries and arranged. Therefore, taking into consideration information about the arrangement of these binding domains in binding to the target substance, nucleic acid sequences of the polypeptide chains available for these binding domains can be selected. Thus, the polypeptide chains necessary for the target substance-binding domains can be selected from polypeptide chain libraries prepared according to the number of the target substance-binding domains. At the point in time when all the polypeptide chains are selected on the target substance, positions of the target substance respectively recognized by the polypeptide chains have already been identified. As a result, the arrangement of linkage of the polypeptide chains has already been optimized. The use of these polypeptide chains makes it possible to systematically obtain the target substance capturing protein with a plurality of target substance-binding domains according to the target substance.

Hereinafter, the present invention will further be described in detail. The method for selecting polypeptide chains according to the present invention has two aspects of:

(A) a method using a combination of a known polypeptide chain with a target substance-binding domain and at least one polypeptide-library; and

(B) a method using a combination of at least two polypeptide libraries.

At first, an appropriate number of a polypeptide chain library for the number of the target substance-binding domains is prepared. In the method (A), the number of the library is (“the number of the target substance-binding domain”—1), whereas in the method (B), the number of the library is the same as the number of the target substance-binding domains.

Polypeptide chains as target substance-binding domain candidates constituting each polypeptide chain library are formed as a large number of polypeptide chains with systematically varying amino acid sequences and chain lengths. For forming this polypeptide chain library, amino acid sequences and second structures expected to provide for specific recognition and binding are taken into consideration based on information about portions capable of becoming recognition regions in a target substance with reference to a structural analysis result of the target substance. Then, the polypeptide chains constituting the library are systematically constructed.

In the latter method (B), that is, when a first polypeptide chain library is reacted with a target substance, a first complex in which the target substance is bonded with the first polypeptide chain is formed in the presence of the first polypeptide chain specifically binding to the target substance in the library. The polypeptide chains unbound with the target substance are removed from the reaction system. Then, the first complex is reacted with a second polypeptide chain library. A second complex in which both the first and second polypeptides are bonded onto the target substance is formed in the presence of the second polypeptide chain capable of specifically recognizing and binding to the target substance in the second polypeptide chain library.

In this context, when the first and second polypeptides bonded onto the target substance are arranged adjacent or close to each other in positional relationship capable of forming an associate via association sites thereof on the target substance, the following complex is obtained: a second complex in which an associate of the first and second polypeptides associated with each other on the target substance is bonded with the target substance. The unassociated first and/or second polypeptides are removed by washing from this, second complex to obtain a third complex in which only the associate is bonded with the target substance. In the case of two target substance-binding domains, the associate of the first and second polypeptides retained by this third complex has a structure in which two polypeptide chains are associated with each other at association sites provided other than the binding domains for the target substance. Thus, nucleic acid sequences of the first and second polypeptides constituting this associate are determined. Based on information thereof, it is possible to produce a target substance capturing protein having the desired structure.

The first polypeptide chain library may be prepared for selecting the known polypeptide chain used in the method (A). In this case, the first polypeptide chain library is reacted with the target substance to form the first complex. Then, the polypeptide chains unbound with the target substance are removed from the reaction system. Subsequently, a nucleic acid sequence of the polypeptide chain specifically bonded with the target substance is determined. Based on information thereof, a polypeptide chain can be prepared and used as the polypeptide chain with the known target substance-binding domain in the method (A). In this method (method (C)), the known polypeptide chain used in the method (A) is selected form the first polypeptide chain library. Therefore, the total number of the libraries is the same as the number of the target substance-binding domains.

Up to this point, the selection of polypeptide chains for two target substance-binding domains has been described. When polypeptide chains are selected for three or more target substance-binding domains, the selection method of the present invention can take the following aspects:

(1) in the method (A), a known polypeptide chain and two or more libraries are used;

(2) in the method (B), three or more libraries are used; and

(3) in the method (C), three or more libraries are used.

Namely, any of the methods (A) to (C) are used to obtain a complex (third complex) in which an associate of two polypeptide chains is bonded onto the target substance via both the polypeptide chains. Thereafter, a required number of prepared libraries is successively used to repeatedly perform the step of reacting the complex with the polypeptide chain library to obtain a complex and the step of washing the obtained complex to obtain a complex in which an associate of a desired number of the polypeptide chains is bonded with the target substance. Then, a target substance capturing protein having the desired structure can be obtained by obtaining nucleic acid sequences of the polypeptide chains respectively selected from the libraries.

If three target substance-binding domains are used in the methods (B) and (C), a third polypeptide chain library is prepared and reacted with the third complex in the same way as above. As a result, a fourth complex in which an associate of the first to third polypeptide chains is bonded onto the target substance is obtained. When four to N target substance-binding domains are required, fourth to N-th polypeptide chain libraries are prepared. Then, the same reaction and washing as above are repeated for each of the polypeptide chain libraries. As a result, a target substance capturing protein can be obtained as an associate of N associated polypeptide chains respectively recognizing and binding to different regions of the target substance.

At the point in time when the fourth complex (or subsequent complex) is formed, nucleic acid sequences of the polypeptide chains forming each complex having the corresponding associate are obtained. A method (method (D) can be performed, wherein first polypeptide chains are prepared based on information thereof and reacted with the target substance as a first polypeptide chain group with known target substance-binding domains clarified by the present invention.

For example, after the reaction of the first library, a nucleic acid sequence of the first polypeptide is obtained. Based on information thereof, a polypeptide is prepared and reacted with the target substance as the first polypeptide with a known target substance-binding domain to select a second library. A nucleic acid sequence of the second polypeptide chain selected from the second library on the target substance is determined to prepare the second polypeptide chain. The first and second polypeptide chains can also be reacted as a polypeptide chain group with known target substance-binding domains.

If required, the third and subsequent libraries are used to prepare a group of an appropriate number (“the total number of the libraries”—1) of known polypeptides for the number of the libraries. This group is reacted with the target substance, followed by the reaction of the final library to obtain the respective nucleotide sequences of a desired number (appropriate number for the total number of the libraries) of polypeptide chains for the target substance-binding domains. The polypeptide chain group in this method (D) corresponds to the known first polypeptide chain in the method (A). The known polypeptide chains may be used successively in reaction and washing or may be given as an associate.

When phage display is used, the nucleic acid sequences of the polypeptide chains selected from the libraries on the target substance are obtained by separating phages displaying the polypeptide chains selected by the target substance and obtaining information about nucleic acids encoding the selected polypeptide chains retained by the phages. Alternatively, in mRNA display, the nucleic acid sequences can be obtained directly from mRNAs corresponding and binding to the polypeptide chains selected by the target substance. For expressing and purifying the target substance capturing protein from the obtained nucleic acid information, a variety of purification techniques can be adopted.

Examples of the purification techniques include affinity purification using a tag sequence arranged in the end of the polypeptide chain, affinity purification with the target substance, chromatography purification according to difference in molecular weight or charge, and combinations thereof.

Hereinafter, one example of the method (A) will be described with reference to drawings. The methods (B) to (D) can be performed by utilizing this method.

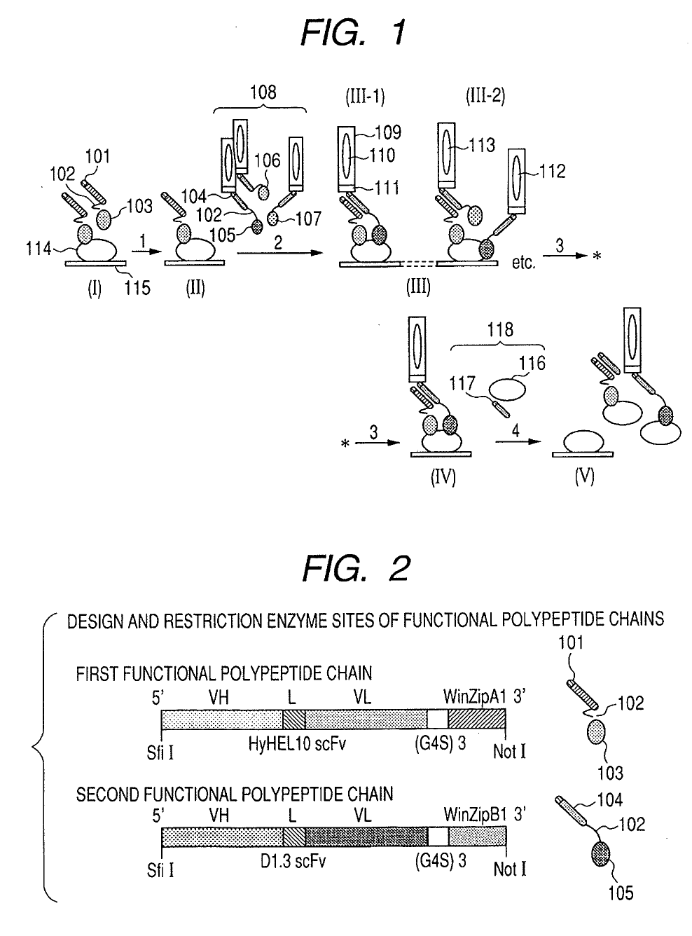

The reaction of a target substance with a first polypeptide chain with a known target substance-binding domain will be described with reference to FIG. 1. Description of reference numerals of FIG. 1 is as follows:
101 refers association site (one chain WinZipA1 of a heterodimeric coiled-coil pair) of a first functional polypeptide chain;
102 refers linker site ((G4S)3 peptide) of the first functional polypeptide chain;
103 refers target molecule-binding domain (antibody fragment scFv with a known sequence) of the first functional polypeptide chain;
104 refers association site (one chain WinZipB1 of the heterodimeric coiled-coil pair) of a second functional polypeptide chain;
105 refers target molecule-binding domain candidate of the second functional polypeptide chain;
106 refers target molecule-binding domain candidate of the second functional polypeptide chain;
107 refers target molecule-binding domain candidate of the second functional polypeptide chain;
108 refers second functional polypeptide chain population;
109 refers M13 phage;
110 refers phagemid DNA encoding the second functional polypeptide chain with the binding domain 105;
111 refers protein (g3p) displayed on the surface of the phage;
112 refers phagemid DNA encoding the second functional polypeptide chain with the binding domain 106;
113 refers phagemid DNA encoding the second functional polypeptide chain with the binding domain 107;
114 refers immobilized antigen;
115 refers carrier (96-well plate);
116 refers free antigen;
117 refers WinZipB1 peptide and;
118 refers affinity elution-solution.

FIG. 1(I) shows a state in which a solution containing a first polypeptide chain with a known target molecule-binding domain (e.g., antibody fragment scFv against an antigen) 103 is added to a target substance (target molecule) 114 (e.g., the antigen) immobilized on a carrier (96-well plate) 115. The first polypeptide chain is composed of a site 101 (e.g., one chain WinZipA1 of a heterodimeric coiled-coil pair) to be associated with a second polypeptide chain and a linker site 102 (e.g., (G4S)3 peptide linker) connecting the binding domain 103 and the site 101, in addition to the target molecule-binding domain (scFv) 103. Redundant first polypeptide chains unbound with the antigen are washed in Procedure 1 to thereby obtain a state shown by FIG. 1(II).

As shown in the drawing, a second polypeptide chain population (library) 108 comprises a large number of molecules composed of a variety of antigen-binding domain candidates (105 to 107), an association site 104 (e.g., WinZipB1) complementary to the site 101, and a linker site 102.

As shown in the drawing, the individual second polypeptide chains (e.g., polypeptide chains containing the candidates 105, 106 and 107) are respectively displayed on phage surfaces, while fused with coat proteins (g3p) 111 of respective M13 phages 109 carrying their encoding nucleic acid sequences (110, 113 and 112 (in the corresponding order)). Procedure 2 represents the step of adding and binding the library 108 to the state shown by the FIG. 1(II). FIG. 1(III) shows a state in which the second polypeptide chains bind to, for example two identical antigens 114 immobilized on the identical carrier 115. FIG. 1(III-1) shows a state in which the first and second polypeptide chains are associated with each other at the complementary association sites 101 and 104 and bonded with the antigen 114 via two binding domains 103 and 105. FIG. 1(III-2) shows a state in which the target molecule-binding domain 106 of the second polypeptide chain is not bonded with the antigen 114 although the first and second polypeptide chains are associated with each other at the association sites 101 and 104. FIG. 1(III-2) further shows the second polypeptide chain that is not associated with the association site 101 of the first polypeptide chain and is bonded with the antigen 114 via the binding domain 107.

Procedure 3 represents the step of removing by washing, low-affinity second polypeptide chains bonded or associated at one location with the antigen-first polypeptide chain complex in the state shown by FIG. 1(II) by utilizing difference in affinity to the complex among the second polypeptide chains. As a result, there remains only the displaying phage having the second polypeptide chain associated with the first polypeptide chain and bonded with a site of the antigen 114 different from that bound by the binding domain 103, as shown in FIG. 1(IV).

Procedure 4 represents the step of eluting the phage displaying the second polypeptide chain bonded with the antigen 114 by adding thereto an affinity elution solution 118 containing an association site peptide 117 of the second polypeptide chain and a free antigen 116. Namely, FIG. 1(V) shows that the association site peptide 117 binds to the association site 101 of the first polypeptide chain in a manner that competes with the association site 104 of the second polypeptide chain displayed in the phage. FIG. 1(V) also shows a state in which the free antigens 116 bind to the target molecule-binding domains 103 and 107 of the first and second polypeptide chains in a manner that competes with the immobilized antigen 114, to elute the second polypeptide chain-displaying phage from the antigen 114.

As a result, the displaying phage having the high-avidity second polypeptide chain associated with the first polypeptide chain and bonded with a site of the antigen 114 different from that bound by the binding domain 103 can be obtained. Then, the nucleic acid sequence 110 encoding the second polypeptide chain retained by this displaying phage is obtained.

The respective association sites of the polypeptide chains are provided at positions that prevent their avidity to the target substance from being reduced.

Moreover, each of the association sites can be designed to avoid the association between the polypeptide chains belonging to the identical library or even if this association occurs, to attain higher associability between this association site and the association sites of the known first polypeptide chain or polypeptide chains belonging to other libraries than associability between the polypeptide chains belonging to the identical library. It is possible to obtain a desired association state on the target substance by selecting each of the association sites.

A washing condition capable of utilizing difference in bond strength to the target substance between the associated polypeptide chains and the unassociated polypeptide chains on the target substance can be selected for the washing step for removing unnecessary polypeptides from the complex. The washing step can be performed by retaining the associated polypeptide chains but removing the unassociated polypeptide chains from the target substance. Moreover, the step of improving the association strength of the associate formed on the target substance can be performed additionally to increase the strength and bond strength of the associate and more stabilize the associate.

Alternatively, target substance capturing proteins having structures intended according to different kinds of target substances can be obtained by immobilizing the target substances at given positions on a substrate and performing the steps such as the reaction with each of the libraries and the washing of the complex. Moreover, the structure of the target substance capturing proteins can also be obtained by reacting a first polypeptide chain specific to each kind of target substance and performing the steps such as the washing of the complex.

The respective polypeptide chains constituting the libraries can be selected according to desired purposes from antibodies, antibody fragments, and those recognizing and binding to the target substance by structures other than antibodies, which can be used alone or in combination. It is desirable that an immunoglobulin structure or derivative thereof should be contained in the polypeptide chains in the library. More preferably, the target molecule-binding domain of the first polypeptide chain contains the immunoglobulin structure or derivative thereof.

Furthermore, the respective association sites of the polypeptide chains may be associated via a linker provided as desired. Preferably, the linker includes a linker whose sequence, design and length can be adjusted.

The target substance that can be used in the present invention includes those selected from the group consisting of antibody-antigen complexes, substrate-enzyme complexes, ligand-receptor complexes, a plurality of molecules on cell surface, homomultimers and heteromultimers.

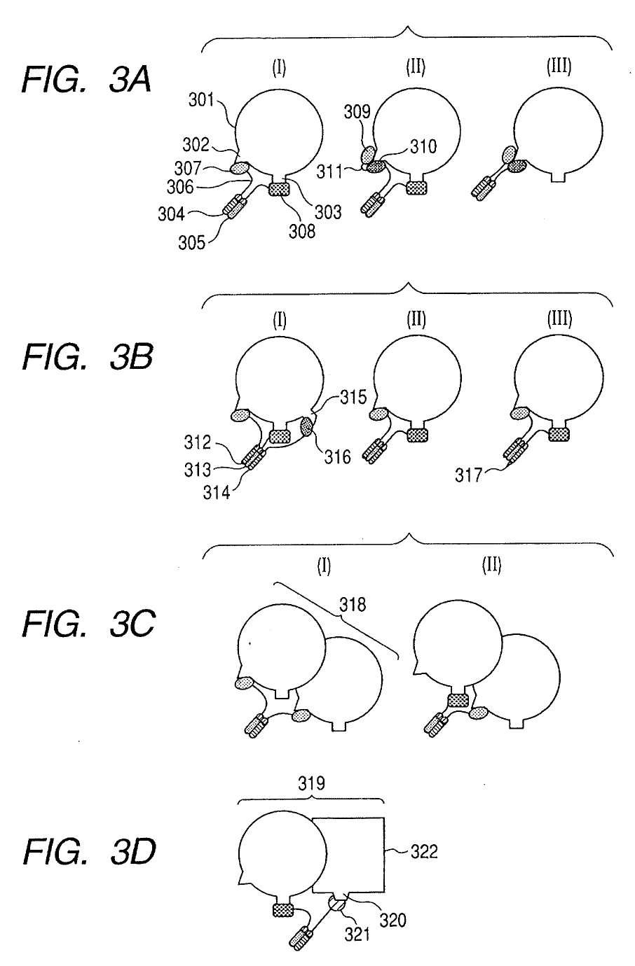

For example, when the target substance is an antibody-antigen complex, the polypeptide chains may be constructed so that at least one of the polypeptide chains binds to the antibody and the other polypeptide chains bind to the antigen. For example, when the target substances are a plurality of molecules on cell surface, the polypeptide chains may be constructed so that at least one of the polypeptide chains binds to at least one of the plurality of molecules present on the cell surface and the other polypeptide chains bind to the molecules other than the bound molecule. Representative examples of binding forms of the polypeptide chains to the target substance are shown in FIG. 3.

Description of Reference Numerals of FIG. 1 is as Follows:

301 refers target molecule;
302 refers site on the target molecule interacting with a nascent protein;
303 refers site on the target molecule interacting with the nascent protein;
304 refers association site of a first functional polypeptide chain;
305 refers association site of a second functional polypeptide chain complementary to the association site 304;
306 refers linker site connecting a target molecule-binding domain and the association site;
307 refers target molecule-binding domain of the functional polypeptide chain binding to the site 302;
308 refers target molecule-binding domain of the functional polypeptide chain binding to the site 303;
309 refers one target molecule-binding domain of the functional polypeptide chain consisting of two complementary domains;
310 refers another target molecule-binding domain (different from the domain 309) of the functional polypeptide chain consisting of two complementary domains;
311 refers linker connecting the two domains (309 and 310);
312 refers one coil as an association site constituting a coiled-coil heterotrimer;
313 refers one coil (different from the coil 312) as an association site constituting the coiled-coil heterotrimer;
314 refers one coil (different from the coils 312 and 313) as an association site constituting the coiled-coil heterotrimer;
315 refers one site on the target molecule bounded by a nascent protein consisting of three functional polypeptide chains;
316 refers target molecule-binding domain of the functional polypeptide chain binding to the site 315 of the target molecule;
317 refers linker site connecting two coils constituting the coiled-coil heterotrimer;
318 refers target molecule group (homodimer of the target molecules 301);
319 refers target molecule group (heterodimer containing the target molecule 301);
320 refers one site located on a target molecule different from the target molecule 301 in the target molecule group and bound by the nascent protein;
321 refers target molecule-binding domain of the functional polypeptide chain binding to the site 320 of the target molecule and;
322 refers target molecule interacting with the target molecule 301.

For example in (I) of FIG. 3A, reference numeral 301 denotes a target molecule (e.g., antigen), and reference numerals 302 and 303 denote sites on the target molecule interacting with a nascent protein. For example, a target molecule-binding domain 307 of a first polypeptide chain of the nascent protein is bonded with this site 302. An association site 304 linked via a linker 306 to the chain is complementarily associated with an association site 305 of a second polypeptide chain. (I) of FIG. 3A further shows a state in which a binding domain 308 of the second polypeptide chain is bonded with a site 303 different from the site 302 on the target molecule.

(II) of FIG. 3A indicates that a region corresponding to the binding domain 307 shown in (I) of FIG. 3A consists of two domains and shows that both the domains 309 and 310 (e.g., antibody fragment Fv) have complementarity to each other and are connected (e.g., scFv) via a linker 311. Namely, (II) of FIG. 3A shows that these two domains 309 and 310 are regarded as one binding domain on the target molecule, and the nascent protein is bonded-with-two different sites 302 and 303 of one target substance.

(III) of FIG. 3A shows that the site 302 (e.g., antigenic determinant) on the target molecule interacting with the nascent protein is bonded with the domains 309 and 31.0 (e.g., VH and VL of an antibody fragment Fv) having complementarity thereto. The domain 309 is a target molecule-binding domain of the first polypeptide chain. (III) of FIG. 3A indicates that the domain 310 is a target molecule-binding domain of the second polypeptide chain and shows that these two different domains of the respective polypeptide chains of the nascent protein are bonded with one target molecule within a region of the site 302.

As shown in (II) of FIG. 3A and (III) of FIG. 3A, the target molecule-binding domains may be associated with each other, in addition to the association between the polypeptide chains. (I) of FIG. 3B shows that the nascent protein is bonded with three different sites in one target molecule. In this case, the nascent protein has sites (heterotrimeric coiled coils) in which three polypeptide chains are complementarily associated with each other. The nascent protein has, for example, an association site 312 of the first polypeptide chain, an association site 313 of the second polypeptide chain and an association site 314 of the third polypeptide chain. (I) of FIG. 3B indicates that a target molecule-binding domain 316 of the third polypeptide chain is bonded with a third site 315 on the target molecule 301 interacting with the nascent protein Namely, it shows a state in which the nascent protein is bonded with three different sites of one target molecule.

(II) of FIG. 3B shows a state in which the number of peptides constituting association sites is not equal to the number of target molecule-binding domains. (III) of FIG. 3B shows a state in which association sites are connected via a linker 317. Of course, (II) of FIG. 3B and (III) of FIG. 3B show the nascent protein is bonded with two different sites of one target molecule and has the association between the polypeptide chains constituting it.

When the target substances are an antibody-antigen complex, a substrate-enzyme complex, a ligand-receptor complex, a plurality of molecules on cell surface, a homomultimer or a heteromultimer, for example (I) of FIG. 3C shows that the target substances 301 form a target molecule group 318 composed of a homodimer. In this context, for example the target molecule-binding domain 307 of the first polypeptide chain is bonded with the site 302 on one target molecule (e.g., monomer) 301 interacting with the nascent protein. The association site 304 linked via the linker 306 to the chain is complementarily associated with the association site 305 of the second polypeptide chain. (I) of FIG. 3C shows a state in which this second polypeptide chain has the same binding domain 307 as that of the first polypeptide chain, and this binding domain 307 of the second polypeptide chain is bonded with an interaction site 302 of another target substance 301 forming the homodimer. Namely, the nascent protein is bonded with two identical sites 302 (indicating the different sites of the present invention) of the respective monomers of the target molecule group 318 composed of the homodimer.

For example, (II) of FIG. 3C shows a state in which the target molecule-binding domain of the second polypeptide chain illustrated in (I) of FIG. 3C is the binding domain 308 different from that of the first polypeptide chain and is bonded with the interaction site 303 of another target molecule 301 forming the homodimer. Namely, the nascent protein is bonded with two different sites 302 and 303 (indicating the different sites of the present invention) of the respective monomers of the target molecule group 318 composed of the homodimer.

For example, FIG. 3D shows that the target molecule 301 and a target molecule 322 interact with each other and form a target molecule group 319 composed of a heterodimer. For example the target molecule-binding domain 308 of the first polypeptide chain is bonded with the site 303 on one target molecule (e.g., monomer) 301 interacting with the nascent protein. The association site 304 linked via the linker 306 to the chain is complementarily associated with the association site 305 of the second polypeptide chain. FIG. 3D shows that this second polypeptide chain has a site 321 binding to an interaction site 320 on the target molecule 322. Namely, the nascent protein is bonded with two different sites 303 and 320 (indicating the different sites of the present invention) of the respective monomers of the target molecule group 319 composed of the heterodimer.

On the other hand, in the selection method of the present invention, a molecule having desired properties can be selected by adjusting the structure of the association site, the design of linker length, and the density of the target substance (group) immobilized on the carrier at the time of selection to thereby suppressing the influence of a neighboring target substance group.

Hereinafter, preferred aspects of the selection method of the present invention will further be described with emphasis on the use of the first and second polypeptides.

In the selection method of the present invention, the associability of sites in which the polypeptide chains are associated with each other can be adjusted at the time of selection by selecting the association sites. More preferably, binding (association) can be stabilized.

In the selection method of the present invention, the selecting (washing) step is performed by allowing, for example, the first polypeptide chains (which may be known polypeptide chains) to act on the target substance immobilized on the carrier and removing the redundant unbound first polypeptide chains by washing. Then, the second polypeptide chain population (library) is allowed to act thereon. Subsequently, the resulting complex is washed under a mild condition (washing condition at a degree that does not dissociate the first polypeptide chain bonded with the target substance but dissociates the second polypeptide chain bonded with the first polypeptide chain at only the association sites). For selecting an associate of the first and second polypeptide chains bonded with the target substance, the association sites are subjected, if necessary, to stabilization treatment. Subsequently, the resulting complex is washed under a severe washing condition (washing condition at a degree that dissociates the second polypeptide chains that are bonded with the target substance (group) due to the unavailability of avidity effect and could not be removed under the mild condition).

The associate of the first and second polypeptide chains has high avidity ability and therefore remains on the target substance by this washing, whereas the unassociated first and second polypeptide chains are removed from the target substance.

In the selection method of the present invention, the washing condition for selecting the associated polypeptide chains having the target substance-binding domains of the desired target substance capturing protein can be determined by utilizing associability and avidity effect on the target substance. The structure of a target substance capturing protein having desired properties can be selected by this washing condition.

For example, when the target substance is a sugar chain, lipid, or conjugated protein thereof, it is preferred that the dissociation constant of the association sites should be more than Kd 1×10⁻⁶ M in the case of the dissociation constant Kd 1×10⁻⁶ M of the first polypeptide chain in the binding domain for the sugar chain or lipid. More preferably, this dissociation constant is more than Kd 5×10⁻⁶ M.

On the other hand, when the target substance is a protein, it is preferred that the dissociation constant of the association sites should be more than Kd 1×10⁻⁸ M in the case of the dissociation constant Kd 1×10⁻⁸ M of the first polypeptide chain in the binding domain for the protein. More preferably, this dissociation constant is more than Kd 1×10⁻⁷M.

The second polypeptide chains bonded with the first polypeptide at only the association sites can be washed out by virtue of difference in dissociation constant by 5 to 10 times. More preferably, the association sites may be stabilized at the point in time when the associate is formed on the target substance. As described above, avidity to the target substance can further be improved by additionally using the third to N-th polypeptide chains. According to circumstances, it is not required to improve avidity (affinity) to the target substance only by one step using the first and second polypeptide chains. A target substance capturing protein with a large number of target substance-binding domains can be obtained by repeating reaction with a larger number of polypeptide libraries.

In the selection method of the present invention, the binding (association) of the polypeptide chains constituting the libraries may be performed by any binding method that can achieve the objects of the present invention. It may be covalent bond, disulfide bond, coordinate bond, noncovalent bond and bond comprising interaction between higher-order structures via polypeptides. Preferably, the binding (association) includes the bond comprising interaction between higher-order structures via polypeptides. Examples thereof include binding by a coiled coil (leucine zipper), helix bundle and helix-turn-helix. Alternative examples thereof can include binding via other biomolecules, for example, DNA or sugar, other bindings capable of multimerization, enzyme-substrate binding and ligand-receptor binding. The binding via the leucine zipper, helix-turn-helix or helix bundle is more preferable. The coiled-coil structure takes two turns per seven amino acids and has seven positions (a, b, c, d, e, f and g). The coiled coil, which takes this heptad repeat structure N, is known to have the a and d positions having a hydrophobic core and the e and g positions residing on the boundary between hydrophilic and hydrophobic regions and having both properties (Tanizawa, et al., Molecular Design of Proteins, Kyoritsu Shuppan, (2001)).

In the selection method of the present invention, bond by interaction between higher-order structures of polypeptides in the association sites of the polypeptide chains constituting the libraries can have a hetero-associating property between the polypeptide chains (polypeptide chain populations) constituting the libraries. Preferably, the hetero-associating property can be stable energetically in the equilibrium between homo-associating and hetero-associating properties. More preferably, the bond can completely have the hetero-associating property. Examples of such a hetero-associate include transcription factors in nature such as Jun/Fos and Myc/Max. Furthermore, artificial design is also possible. For example, the hetero-associating property can be improved by arranging Asn (for double strands) or Gln (for triple strands) in the a position of the hydrophobic core located around the center of the repeat structure in WinZipA/WinZipB (Pluckthun et al., id.) or the association sites of the polypeptide chains.

In the present invention, the stabilization of the binding (association) of the polypeptide chains constituting the libraries may be performed as follows: the stabilization may be performed using any one or combination of disulfide bond, bond via a metal chelate (e.g., Ni and Cu) and covalent bond (bond via chemically modifying groups, which introduces modified amino acids into the association sites or their neighboring regions). More preferably, the disulfide bond that can control the binding state under oxidation-reduction conditions, or the bond via a His-Ni metal chelate that can control the binding state by the addition of chelating agents or metal solutions is available. Moreover, bond capable of crosslinking by light irradiation by introducing a photo-crosslinking nonnatural amino acid to the association sites or their neighboring regions is available. For example, when the coiled coil is stabilized by disulfide bond, it is preferred that Cys residues should be introduced into the d and a positions of the double-stranded coiled coil. More preferably, the Cys residue can be introduced into the d position. For example, when the coiled coil is stabilized by metal chelate bond, γ-carboxylglutamic acid can be introduced into the e and g positions.

Furthermore, the coiled coil can be stabilized by the addition of lanthanide ions. Because metal ions can bind to two positions, i-th and i+4th histidine residues, of the amino acid sequence, the coiled coil can be stabilized with nickel II ions by introducing the His residues into the d and a positions as described above. The triple-stranded coiled coil can be stabilized in the same way. For example, the coiled coil can be stabilized by photo-crosslinking bond as described above.

The coiled coil can be stabilized by UV irradiation by introducing photo-leucine or photo-methionine (Christoph Thiele et al., Nature Methods Advanced online publication 1-7 (2005)) or p-benzoylphenylalanine (T. Endo et al., PNAS 94:485-490 (1997)) into any of the a, d, e and g positions of the coiled coil. More preferably, this control of stability is performed after the washing of the second polypeptide chain population under the mild condition. The control of stability can be performed at the stage of production of a high-avidity nascent protein from the finally selected polypeptide chains. For example, when disulfide bond is used in each of the polypeptide chains in which Cys residues are introduced into appropriate sites of the respective association sites, the stabilization can be achieved by allowing the second polypeptide chain population to act on the first complex under reduction conditions and washing the resulting complex under the mild condition, followed by conversion to oxidation conditions. For example, when metal chelate bond is used in each of the polypeptide chains in which His residues are introduced into appropriate sites of the respective association sites, the stabilization can be achieved by allowing the second polypeptide chain population to act on the first complex in the absence of an Ni-containing solution and washing the resulting complex under the mild condition, followed by the addition of an Ni solution. For example, when covalent bond is used in each of the polypeptide chains in which, for example, p-benzoylphenyl Ala residues (T. Endo et al., id.) with benzophenone groups as functional groups introduced by four-base codon method (T. Hohsaka et al., Appl Microbiol Biotechnol 57: 247-281 (2001)) are introduced into appropriate sites of the respective association sites, the stabilization can be achieved by allowing the second polypeptide chain population to act on the first complex and washing the resulting complex under the mild condition, followed by photo-crosslinking by UV irradiation. Photo-crosslinking groups do not have to be introduced directly into the amino acids and may be added chemically, for example after the introduction of biotinylated amino acids.

In the selection method of the present invention, association strength at the association sites can be adjusted by changing the association degree of the coiled coil or amino acid residues at the a and d positions of the hydrophobic core. For example, double strands can be converted to highly associating triple strands or quadruple strands by a combination comprising Ile and Leu.

In the selection method of the present invention, the structures of the binding domains for the target substance retained by the polypeptide chains constituting the libraries can be any one or combination of immunoglobulin structures, structures induced from immunoglobulin and non-immunoglobulin structures. The immunoglobulin structures and the structures induced from immunoglobulin may be structures derived from immunoglobulin super family. Preferably, the binding domains are antibody fragments and may be Fab, Fd, Fv, dAb (Ward, E. S. et al., Nature 341, 544-546 (1989)) and VH/k fragments. More preferably, the antibody fragments can be single-stranded Single-stranded structures having any of the antibody fragments and single-stranded structures comprising VHH or IgNAR can also be utilized. Even more preferably, the binding domains can preserve the immunoglobulin structure and can be mutagenized artificially. The non-immunoglobulin structures comprise peptides, structural proteins, functional proteins (including enzymes and receptors), fragments thereof or derivatives thereof and may be peptides or polypeptides designed de novo. Preferably, the non-immunoglobulin structures can be polypeptides having scaffold structures (including de-novo designed proteins, existing proteins and derivatives thereof). More preferably, the non-immunoglobulin structures can be polypeptides capable of being artificially mutagenized. They can comprise antibodies, Affilin (human γ-crystallin), lipocalin, GFP, ankyrin, lectin, thioredoxin, Omp (outer membrane protein), fragments thereof or derivative thereof. The fragments can comprise, for example, portions (e.g., Fc-binding domains; affibody) other than the antigen-binding domains of antibodies. The derivatives can comprise other molecules, for example, proteins with target substance-binding domains fused with enzymes.

An associate of a plurality of polypeptide chains selected by the selection method explained above already possesses, by itself, a structure that can be utilized as a target substance capturing protein having properties of interest. Furthermore, information (amino acid sequences and the structure of association sites) about this structure of the target substance capturing protein can be used to produce a target substance capturing protein. For example, DNAs encoding the selected polypeptide chains are prepared and introduced into E. coli or the like in a manner capable of their expression. The target substance capturing protein can be obtained by creating an associate of the expressed polypeptides associated with each other. Furthermore, the target substance capturing protein can be produced by expressing the target substance capturing protein in E coli or the like from a single-stranded polypeptide chain of a plurality of polypeptide chains bonded via linkers without the use of the association sites used for selecting these polypeptide chains. In such a case, the linkers can be optimized easily based on information about the association state of the association sites at the time of selection. As described above, the association sites in the target substance capturing protein finally produced may be modified or exchanged into other association sites with different associating patterns or other association sites with the same structures differing in associability, based on the information about the association sites used in the selecting step. Then, they can be made into association sites suitable for the purpose and application of the target substance capturing protein.

Nucleic acids encoding the respective polypeptides constituting the polypeptide chain libraries are maintained as libraries, and polypeptide chain libraries can be formed based on the genetic information of these nucleic acids. Moreover, expression vectors for this purpose can also be maintained as an expression vector library group.

Kits for selecting the polypeptide chains can be constructed by using at least one library. These kits can include the following forms:

(1) a kit for selecting polypeptide chains comprising: a set comprising the polypeptide chain library; and reagents for reaction between a target substance and the polypeptide chain set, for the washing of complexes and for the acquisition of the complex of interest from the complexes;

(2) a kit for selecting polypeptide chains comprising:

a set comprising the nucleic acid library; a reagent for obtaining a polypeptide chain set comprising the polypeptide chain library group with the use of the nucleic acid set; and reagents for reaction between a target substance and the polypeptide chain set, for the washing of complexes and for the acquisition of the complex of interest from the complexes; and

(3) a kit for selecting polypeptide chains comprising:

a set comprising the expression vector library; a reagent for obtaining a polypeptide chain set comprising the polypeptide chain library with the use of the expression vector set; and reagents for reaction between a target substance and the polypeptide chain set, for the washing of complexes and for the acquisition of the complex of interest from the complexes.

The libraries constituting the polypeptide chain library group can be composed of polypeptide chains having structures founded on polypeptide chains selected by phage selection for the target substance or polypeptide chains selected by mRNA selection for the target substance. Based on the polypeptide chains selected by these selection techniques, polypeptide chains having a variety of genetic variations or polypeptide chains having a variety of artificial mutations can be maintained in the libraries.

When the polypeptide chain libraries are formed by using phage display, the libraries can be provided as libraries of phages displaying the polypeptide chains on their surfaces. When the polypeptide chain libraries are formed by using mRNA display, the libraries can be provided as complex libraries comprising complexes of mRNAs encoding the polypeptide chains and the polypeptide chains.

When the phage display is utilized by using the libraries of the respective nucleic acids encoding the polypeptides, the nucleic acid libraries can be provided as the following nucleic acid library: a nucleic acid library comprising: nucleic acid sequences encoding the polypeptide chains; nucleic acid sequences encoding fusion proteins for displaying the polypeptide chains on the surfaces; and nucleic acid sequences involved in expression and selection in the phages. When the mRNA display is utilized, the nucleic acid libraries can be provided as a nucleic acid library comprising: nucleic acid sequences encoding the polypeptide chains; and nucleic acid sequences added for helping the transcription and translation by ribosomes or nucleic acid sequences helping the formation of complexes after transcription and translation.

In the present invention, information about the polypeptide libraries can also be preserved as libraries of expression vectors for preparing the nucleic acid libraries for performing any of the selection techniques.

### EXAMPLES

Hereinafter, the present invention will be described more fully with reference to Examples. However, the scope of the present invention is not intended to be limited to these Examples.

These Examples demonstrate the feasibility of obtaining polypeptide chains by a selection method of the present invention and high affinity to a target substance by high avidity effect that is the characteristic of a nascent protein of the present invention. In Examples described below, soluble hen egg-white lysozyme (HEL; Seikagaku Corp., code No. 100940) is used as the target substance. A recombinant DNA technique described below is performed based on Sambrook et al. Molecular Cloning: A Laboratory Manual, 2nd ed., Cold Spring Harbor Laboratory, New York (1989). Selection by phage display is faithfully performed by using Amersham RPAS (Recombinant Phage Antibody System; Code Nos. 27-9400-01, 27-9401-01 and 27-9402-01).

### Example 1

<Design and Construction of Constructs for Secreting and Expressing Functional Polypeptide Chains in E. coil>

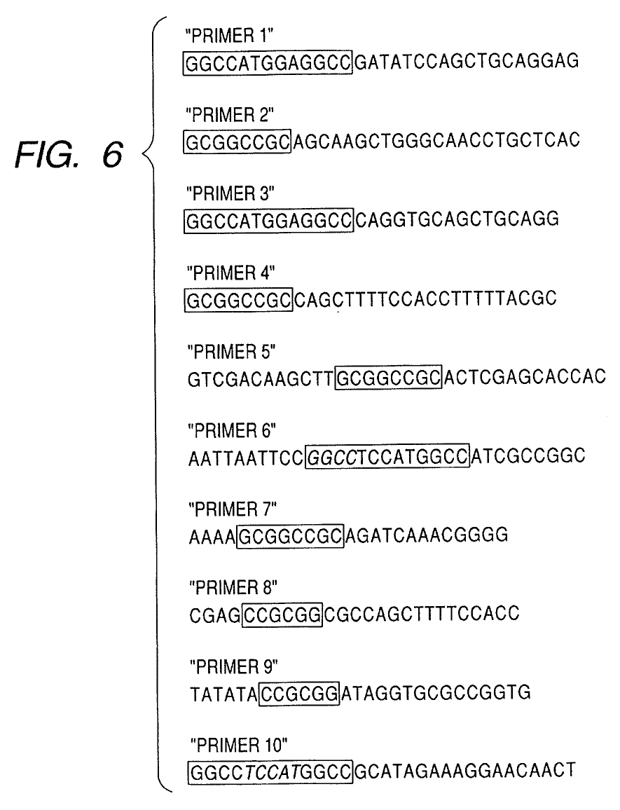

At first, functional polypeptide chains are designed to have structures described below. The functional polypeptide chains have target substance-binding domains, association sites between the functional polypeptide chains, and linker sites connecting the binding domains and association sites. Anti-HEL antibody fragments HyHEL10 scFv (Biophysical Journal Vol. 83, 2946-2968 (2002)) and D1.3 scFv (McCafferty et al., Nature 348, 552-554 (1990)) are used as the target substance-binding domains. A WinZipA1/WinZipB1 combination (Andreas Pluckthun et al., J. Mol. Biol. 295, 627-639 (2000)) having a hetero-associating property is used in the association sites between the functional polypeptide chains. (Gly4Ser)3 peptides are used in the linker sites. Similarly, the (Gly4Ser)3 peptide is connected between VH and VL of the scFv of the target substance-binding domain (FIG. 2). In Examples described below, a peptide HyHEL10 scFv-(G4S)3-WinZipA1 having HyHEL-10 scFv and WinZipA1 is used as a first functional polypeptide chain. A peptide D1.3 scFv-(G4S)3-WinZipB1 having D1.3 scFv and WinZipB1 is used as a second functional polypeptide chain. Because the DNA sequence of each of the domains or sites is known in the art, the respective DNA sequences encoding the functional polypeptide chains can be obtained by designing, for example, synthetic oligonucleotides, followed by PCR and ligation (Sambrook et al., 1989, id). The permutation and sequence of each of the domains or sites are shown in FIGS. 2, 4 and 5. The DNA sequences encoding the functional polypeptide chains are subjected at the final step to PCR using Primers 1, 2, 3 and 4 (sequences; FIG. 6) for introducing a restriction enzyme SfiI site into the 5′ terminus and a restriction enzyme NotI site into the 3′ terminus.

(Primers 1 and 2: primers for HyHEL10 scFv-(G4S)3-WinZipA1, Primers 3 and 4: primers for D1.3 scFv-(G4S)3-WinZipB1)

Then, the PCR products are cleaved with SfiI and NotI restriction enzymes. pET-20b(+) vectors (Novagen) having an E. coil secretion signal sequence pelB are modified and used as recipient vectors.

This modification is performed by cleaving the vector at EcoRI in MCS and introducing a restriction enzyme SfiI site into NcoI and EcoRV sites located in the MCS of the pET-20b(+) vector by PCR with Primers 5 and 6 (sequences are shown in FIG. 6)

(Kunkel Method; Kunkel et al., Meth. Enzymol. 154, 367-382 (1987)).

After cleavage with SfiI/NotI, the respective DNA fragments encoding the polypeptides are separately ligated between the SfiI/NotI sites of the modified pET-20b(+) vectors (Novagen) to obtain constructs secreting and expressing the functional polypeptide chains

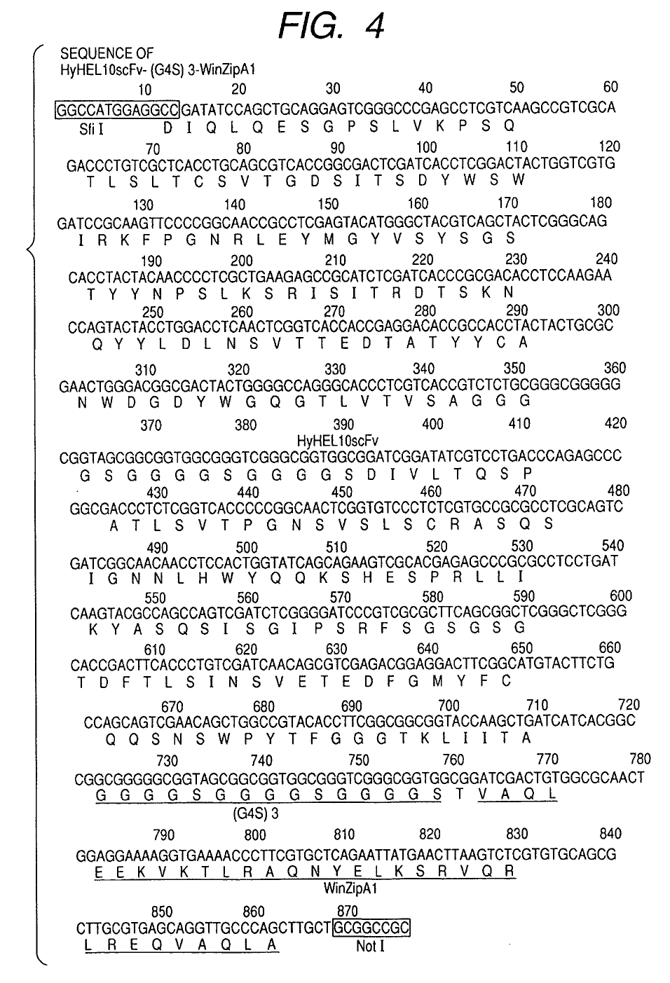

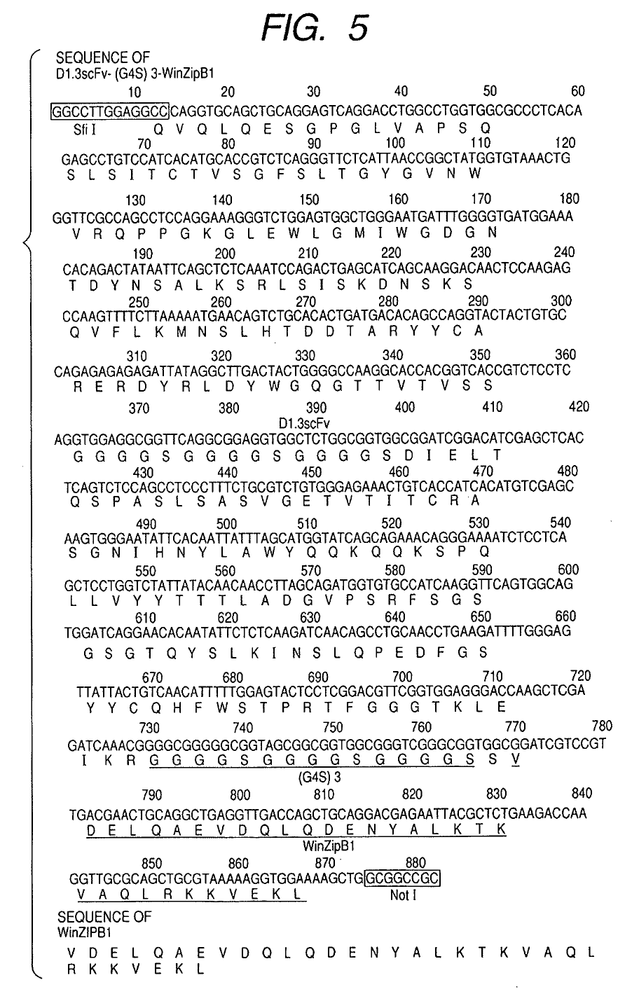

The functional polypeptide chain-encoding DNA sequence located between the SfiI and NotI sites and DNA sequence of HyHEL10 scFv-(G4S)3-WinZipA1 (SEQ ID NOs: 1 and 2) and DNA sequence of D1.3 scFv-(G4S)3-WinZipB1 (SEQ ID NOs: 2 and 3) are shown in FIGS. 4 and 5.

### Example 2

<Construction of Phagemid Constructs Used in Phage Display>

RE: second functional polypeptide D1.3 scFv-(G4S)3-WinZipB1

At first, the pCANTAB 5 E phagemid vector included in RPAS Expression Module, a kit for preparing expression constructs, of Amersham Recombinant Phage Antibody System (RPAS) is prepared by cleavage with SfiI/NotI. The D1.3 scFv-(G4S)3-WinZipB1 construct constructed in Example 1 is cleaved with SfiI/NotI. Subsequently, the band of interest is excised by electrophoresis and ligated between the SfiI/NotI sites of the pCANTAB 5 E phagemid vector to construct pCANTAB 5 E-(D1.3 scFv-(G4S)3-WinZipB1). The PRAS system is a phage display system that can express scFv fragments of a variety of mouse (κ) antibodies as fusion proteins with phage gene 3 proteins (g3p) on the M13 phage tips and select the recombinant scFv fragments having high affinity to the antigen.

RE: population of additional scFv-(G4S)3-WinZipB1

PCR is performed using the D1.3 scFv-(G4S)3-WinZipB1 construct as a template and Primers 7 and 8 (sequences are shown in FIG. 6) to prepare (G4S)3-WinZipB1 fragments having NotI at the 5′ terminus and SacII at the 3′ terminus (NotI-(G4S)3-WinZipB1-SacII). In this process, the Primer 8 is constructed so as not to contain the NotI site used in the introduction of the D1.3 scFv-(G4S)3-WinZipB1 sequence into the modified pET-20b(+). Primers 9 and 10 (sequences are shown in FIG. 4) for introducing site-specific mutation and a SacII site into the NotI site of the pCANTAB 5 E phagemid vector included in RPAS Expression Module (kit of Amersham Recombinant Phage Antibody System (RPAS)) are designed. Subsequently, PCR is performed (Kunkel Method, id.), followed by cleavage with SfiI and SacII restriction enzymes to obtain a SfiI/SacII-cleaved pCANTAB 5 E phagemid vector.

A population of a variety of recombinant scFv fragments is prepared from mouse hybridoma culture (the number of cells added: 5×10⁷ cells) according to the protocol described in RPAS mouse ScFv Module (Amersham RPAS kit for preparing expression constructs). In this procedure, the fragments are prepared in a state in which they are cleaved with SfiI/NotI for insertion into phagemid. After the preparation, the fragments are ligated to the previously prepared (G4S)3-WinZipB1 fragments (NotI-(G4S)3-WinZipB1-SacII) and further introduced into the SfiI/SacII-cleaved pCANTAB 5 E phagemid vectors to prepare a population of additional second functional polypeptide chains scFv-(G4S)3-WinZipB1.

### Example 3

<Achievement of High Affinity (High Avidity) to HEL by Association of Functional Polypeptide Chains Having D1.3 scFv and HyHEL10 scFv>

The respective constructs prepared in Example 1, which encode the first functional polypeptide chain (HyHEL10 scFv-(G4S)3-WinZipA1) and the second functional polypeptide chain (D1.3 scFv-(G4S)3-WinZipB1) are separately transformed into E. coil BL21 (DE) strains (Novagen; Cat. No. 69450-4). The strains are cultured at 30° C. for 16 hours in ampicillin (100 μg/ml)-selective LB medium. IPTG is added thereto at the final concentration of 1 mM, followed by additional 16-hour culture to induce protein expression. The bacterial cells collected by centrifugation are subjected to osmotic pressure treatment (the bacterial cells are mixed with 0.5 M sucrose solution and supplemented with a 5-fold volume of pure water) and disrupted by French press to obtain as soluble fractions, the proteins of interest present in the E. coli periplasms. Next, the functional polypeptide chains are purified with HEL columns (HEL is adsorbed and immobilized onto CNBr-activated Sepharose 4B (Code No. 17-0430-01 (Amersham)); the immobilization is performed according to the accompanying protocol). The binding ability between the functional polypeptides and the target substances (HEL) is evaluated by using BIAcore (registered trademark) X (SPR measurement apparatus). At first, 100 nM of the target substances (HEL) is immobilized on BIAcore CM5 Sensor Chip at a coating density on the order of 7000 molecules/mm² (state in which the target substance group is sparsely immobilized and does not interact with the functional polypeptide chains adjacent thereto) by an amino coupling method (Amine Coupling Kit; BIAcore), and subsequent procedures up to blocking are performed. Next, the molarity of the functional polypeptide chain is adjusted to 50 nM, 100 nM and 200 nM for the first functional polypeptide chain (HyHEL10 scFv-(G4S)3-WinZipA1), the second functional polypeptide chain (D1.3 scFv-(G4S)3-WinZipB1) and a 1:1 mixture of the first and second functional polypeptide chains by using PBS-T (0.1% Tween 20) buffer. Each of the resulting solutions is allowed to act on the immobilized target substances (HEL) to calculate respective dissociation constants of the functional polypeptide chains for the HEL. As a result, the mixture of the first and second polypeptide chains has a 2-digit lower value than the dissociation constant of either of the functional polypeptide chains for the HEL, and high affinity by avidity effect can therefore be demonstrated (Table 1).

TABLE 1
Table 1: Comparison of abilities to bind to HEL (Calculation
of dissociation constant (Kd) with SPR apparatus)

| | First | Second | Mixing ratio of |
|---|---|---|---|
| | polypeptide | polypeptide | first and second |
| | chain | chain | polypeptide chains |
| Mixing | 1:0 | 0:1 | 1:1 |
| ratio of | | | |
| polypeptide | | | |
| chains | | | |
| Type of | HyHEL10scFv- | D1.3scFv- | HyHEL10scFv- |
| polypeptide | (G4S)3- | (G4S)3- | (G4S)3-WinzipA1/ |
| chain | WinZipA1 | WinZipB1 | D1.3scFv-(G4S)3- |
| | | | WinZipB1 |
| Kd(M) | 3 × 10⁻¹⁰ | 3 × 10⁻⁹ | 1 × 10⁻¹² |

### Example 4

<Selection of Second Functional Polypeptide Chain by Phage Display>

The pCANTAB 5 E-(D1.3 scFv-(G4S)3-WinZipB1) phagemid DNA prepared in Example 2 is added at a molar ratio of 1:10⁸ with respect to the total amount of the pCANTAB 5 E-(additional mouse scFv-(G4S)3-WinZipB1) population phagemid DNAs. These phagemid constructs are subjected to transformation into competent cells TG1 (E. coil), culture and subsequent steps according to the operational procedures of RPAS (Amersham).

A panning process of the phage display by RPAS (Amersham Pharmacia) is summarized below. The phagemid constructs are transformed into the competent cells TG1 (E. coli) and amplified after coinfection with KO7 helper phage. The resulting phages are bonded (panning against the antigen; detection by ELISA) with the 96-well plate in which the HEL is crosslinked and immobilized by the amino coupling method. The unbound M13 phages are washed out, and the phages are affinity-eluted with 0.2 M HEL and WinZipB1 solutions. E. coil (TG1) is infected with the obtained M13 phages and plate-cultured, and the above-described procedures are repeated. The selected M13 phages are cloned as phagemids into E. coil HB2151 to express proteins. The scFv fractions of interest are confirmed by Western analysis and sequenced.

Because the binding rate of the phages exhibits a gradual upward tendency by performing three rounds of panning by the M13 phage surface display, it is considered that the selection of the phages having specific avidity can be accomplished. The affinity elution step is performed by using both of the HEL and the WinZipB1 peptide because of very high affinity. The WinZipB1 peptide (Sequence is shown in FIG. 5 (SEQ ID NO: 5)) used is a chemically synthesized product (TORAY RESEARCH CENTER, Inc). Fifteen phages are randomly selected from the finally selected phages. The primers (pCANTAB 5 Sequencing Primer set (Amersham)) included in RPAS are used to determine nucleotide sequences of the scFv regions in the 15 selected phagemids. As a result, 14 of the 15 clones carry the D1.3 scFv-(G4S)3-WinZipB1 sequence. This indicates very high affinity and supports specific selection.

Namely, Examples disclosed herein demonstrate that high-affinity proteins can be selected very conveniently and efficiently by the conventional phage display by utilizing the structure of the avidity nascent protein of the present invention. According to Examples disclosed herein, it is possible to select the high-avidity nascent protein conveniently, systematically and efficiently with the use of avidity effect, regardless of the presence or absence of known antigen-binding domains, regardless of the presence or absence of immunoglobulin structures and regardless of the types of display techniques.

The present invention provides a selection method that can conveniently and systematically create molecules with high affinity to a target substance. The selection method of the present invention is an approach that can achieve effective and practical selection based on the molecular structure of the final high-affinity molecule (high-avidity molecule).

This application claims priority from Japanese Patent Application No. 2005-164550 filed Jun. 3, 2005, which is hereby incorporated by reference herein.

What is claimed is:

1. A method for selecting a combination of polypeptide chains used in the respective target substance-binding domains of a target substance capturing protein with a plurality of target substance-binding domains by utilizing a polypeptide chain library, comprising the steps of:
(1) reacting a target substance with a first polypeptide chain with a known target substance-binding domain to obtain a first complex consisting of the target substance and the first polypeptide chain specifically binding to the target substance;
(2) reacting the first complex with a second polypeptide chain library composed of polypeptide chains each having a site to be associated with the first polypeptide chain to obtain second complexes in which the second polypeptide chain specifically binding to the target substance in the library is bonded with the target substance in the first complex;
(3) washing the second complexes to obtain a third complex in which the first polypeptide chain and the second polypeptide chain are associated with each other and bonded with the target substance; and
(4) obtaining a nucleic acid sequence of the second polypeptide chain from the third complex.

2. The selection method according to claim 1, wherein first to n-th (n represents an integer of 3 or larger) polypeptide chain libraries are prepared, wherein polypeptide chains respectively selected from the libraries are capable of being associated with each other via association sites thereof; the third to n-th polypeptide chain libraries are successively used to repeatedly perform the steps (2) and (3) for the third complex obtained by the steps (1) to (3) using the first polypeptide chain with a known target substance-binding domain and the second polypeptide chain; the step (4) is performed to obtain a complex in which an associate of n polypeptide chains respectively selected from the libraries is bonded with the target substance; and nucleic acid sequences of the polypeptide chains respectively selected from the libraries in a state in which the polypeptide chains are associated with each other on the target substance are obtained.

3. A method for selecting from polypeptide chain libraries, polypeptide chains used in the respective target substance-binding domains of a target substance capturing protein with a plurality of target substance-binding domains, comprising the steps of:
(1) reacting a target substance with a first polypeptide chain library to obtain a first complex consisting of the target substance and the first polypeptide chain specifically binding to the target substance;
(2) reacting the first complex with a second polypeptide chain library composed of polypeptide chains each having a site to be associated with the first polypeptide chain to obtain second complexes in which the second polypeptide chain specifically binding to the target substance in the library is bonded with the target substance in the first complex;
(3) washing the second complexes to obtain a third complex in which the first polypeptide chain and the second polypeptide chain are associated with each other and bonded with the target substance; and
(4) obtaining nucleic acid sequences of the first polypeptide chain and the second polypeptide chain from the third complex.

4. The selection method according to claim 3, wherein first to m-th (m represents an integer of 3 or larger) polypeptide chain libraries are prepared, wherein polypeptide chains respectively selected from the libraries are capable of being associated with each other via association sites thereof; the third to m-th polypeptide chain libraries are successively used to repeatedly perform the steps (2) and (3) for the third complex obtained by the steps (1) to (3) using the first polypeptide chain library and the second polypeptide chain library to obtain a complex in which an associate of m polypeptide chains respectively selected from the libraries is bonded with the target substance; and performing the step (4) to obtain nucleic acid sequences of the polypeptide chains respectively selected from the libraries in a state in which the polypeptide chains are associated with each other on the target substance are obtained.

5. The selection method according to any of claims 1 to 4, wherein a plurality of different target substances are arranged at given positions on a carrier to obtain respective associates specific to the target substances.

6. The selection method according to any of claims 1 to 4, wherein the washing step is performed under a condition capable of retaining the associated polypeptide chains bound on the target substance but removing other polypeptide chains from the target substance by utilizing difference in bond strength to associated polypeptide chains and the unassociated polypeptide chains.

7. The selection method according to any of claims 1 to 4, wherein the method further comprises the step of improving the association strength of the associate.

8. A method for producing a target substance capturing protein, comprising the steps of:
(I) selecting two or more polypeptide chains capable of specifically binding to different sites of a target substance and being associated with each other by a method according to any one of claims 1 to 4;
(II) producing the two or more polypeptide chains; and
(III) connecting the two or more polypeptide chains produced to obtain a target substance capturing protein with a plurality of respective binding domains specifically binding to the different sites of the target substance.

9. A polypeptide chain set for supplying polypeptide chains having target substance-binding domains of a target substance capturing protein with first and second to k-th (k represents an integer of 3 or larger) target substance-binding domains (including a target substance capturing protein, consisting of the first and second target substance-binding domains), comprising:
(1) a known polypeptide chain for the first target substance-binding domain; and
(2) a polypeptide library having candidates of the second target substance-binding domain or second to k-th polypeptide libraries categorized in terms of respective candidates of the second to k-th target substance-binding domains,
wherein the first polypeptide chain and the polypeptide chains respectively selected from the libraries are capable of being associated with each other.

10. A polypeptide chain set for supplying polypeptide chains forming target substance-binding domains of a target substance capturing protein with first to p-th (p represents an integer of 2 or larger) target substance-binding domains, comprising:
first to p-th polypeptide chain libraries having respective candidates of the first to p-th target substance-binding domains,
wherein the first polypeptide chain and the polypeptide chains respectively selected from the libraries are capable of being associated with each other.

11. A nucleic acid set comprising nucleic acids respectively encoding polypeptide chains constituting a polypeptide chain set according to claim 9 or 10.

12. An expression vector set comprising individual expression vectors respectively having nucleic acids according to claim 11.

13. A kit for selecting polypeptide chains for target substance capturing protein production, comprising:
a polypeptide chain set according to claim 9 or 10; and reagents for reaction between a target substance and the polypeptide chain set, for the washing of complexes and for the acquisition of the complex of interest from the complexes.

14. A kit for selecting polypeptide chains for target substance capturing protein production, comprising:
a nucleic acid set according to claim 11; a reagent for obtaining a polypeptide chain set with the use of the nucleic acid set; and reagents for reaction between a target substance and the polypeptide chain set, for the washing of complexes and for the acquisition of the complex of interest from the complexes.

15. A kit for selecting polypeptide chains for target substance capturing protein production, comprising:
an expression vector set according to claim 12; a reagent for obtaining a polypeptide chain set with the use of the expression vector set; and reagents for reaction between a target substance and the polypeptide chain set, for the washing of complexes and for the acquisition of the complex of interest from the complexes.
